(19) United States
(12) Patent Application Publication
(10) Pub. No.: US 2025/0381843 A1
(43) Pub. Date: Dec. 18, 2025

(54) CARRIAGE COUPLING DEVICE

(71) Applicant: KABUSHIKI KAISHA TOYOTA JIDOSHOKKI, Kariya-shi (JP)

(72) Inventor: Masaru SHAMOTO, Kariya-shi (JP)

(73) Assignee: KABUSHIKI KAISHA TOYOTA JIDOSHOKKI, Kariya-shi (JP)

(21) Appl. No.: 19/233,223

(22) Filed: Jun. 10, 2025

(30) Foreign Application Priority Data
Jun. 14, 2024 (JP) 2024-096570

(51) Int. Cl. B60K 28/10; B60D 1/02

(52) U.S. Cl. CPC B60K 28/10; B60D 1/025

(57) ABSTRACT

A carriage coupling device couples a carriage to a towing vehicle. The carriage coupling device includes a coupling pin, a stopper, a drop detection sensor, and a controller. The coupling pin is configured to drop along a guide toward an insertion position into which a connector of the carriage is inserted. The stopper is biased to advance to the insertion position, supports the coupling pin above the insertion position in an advanced state to the insertion position, and allows the coupling pin to drop to the insertion position when retracting from the insertion position. The drop detection sensor detects a drop of the coupling pin to the insertion position. The controller outputs instruction information to stop a backward movement of the towing vehicle to a travel controller of the towing vehicle when the drop detection sensor detects the drop of the coupling pin to the insertion position.

### CROSS-REFERENCE TO RELATED APPLICATION

This application claims priority to Japanese Patent Application No. 2024-096570 filed on Jun. 14, 2024, the entire disclosure of which is incorporated herein by reference.

### BACKGROUND ART

The present disclosure relates to a carriage coupling device.

In a technique related to a carriage coupling device for coupling a carriage to a towing vehicle, for example, there is a coupling device described in Japanese Utility Model Application Publication No. 63-54501. The conventional coupling device is a device provided at a rear portion of a towing vehicle. The coupling device includes a pair of flange portions that are vertically away from each other, a stopper having a U-shaped cross section and rotatably supported between the flange portions, and a coupling pin that is insertable through holes opened to face each other in the vertical direction in the pair of flange portions. In the coupling device of Japanese Utility Model Application Publication No. 63-54501, when a carriage side connection unit is pushed into the stopper between the flange portions, the stopper is released and the coupling pin drops. As a result, the coupling pin is inserted through the connection unit, and the towing vehicle and the carriage are coupled.

In recent years, it is assumed that an automatic traveling vehicle is used as a towing vehicle. In a case where the towing vehicle is an automatic traveling vehicle, for example, it is necessary to perform coupling in consideration of an error in the position of a carriage placed at a predetermined place. In this case, when the error of the position of the carriage in the traveling direction of the towing vehicle is, for example, ±X mm, in order for the coupling pin to be more reliably inserted by the connection unit of the carriage, the traveling of the towing vehicle is controlled so that the towing vehicle moves backward to a position (the position of −X mm from the reference) of the carriage that is farthest from the towing vehicle.

However, in such control, when the carriage is located at a position (the position of +X mm from the reference) closest to the towing vehicle, the carriage is coupled to the towing vehicle at the position of +X mm, and then, is pushed by the towing vehicle by (2×X) mm to move backward. When the carriage is pushed by the towing vehicle, it is conceivable that the control of the driven wheel of the carriage does not work and the carriage moves backward while deviating in the width direction. For this reason, it is necessary to set an entry prohibition area of a person and an object in consideration of a range in which the carriage deviates and travels, and there is a possibility that a layout of the transport system using the towing vehicle and the carriage is limited.

The present disclosure has been made to solve the above problems, and is directed to providing a carriage coupling device capable of suppressing a backward movement of a carriage when the carriage is coupled to a towing vehicle.

### SUMMARY

In accordance with an aspect of the present disclosure, there is provided a carriage coupling device that couples a carriage to a towing vehicle. The carriage coupling device includes a coupling pin, a stopper, a drop detection sensor, and a controller. The coupling pin is configured to drop along a guide toward an insertion position into which a connector of the carriage is inserted. The stopper is biased to advance to the insertion position, supports the coupling pin above the insertion position in an advanced state to the insertion position, and allows the coupling pin to drop to the insertion position when retracting from the insertion position. The drop detection sensor detects a drop of the coupling pin to the insertion position. The controller outputs instruction information to stop a backward movement of the towing vehicle to a travel controller of the towing vehicle when the drop detection sensor detects the drop of the coupling pin to the insertion position.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a diagram illustrating an example of a travel route in a transport system using a towing vehicle and a carriage;

FIG. 2 is a block diagram illustrating a configuration of the towing vehicle to which a carriage coupling device according to the present embodiment is applied;

FIG. 3 is a perspective view illustrating a configuration of the carriage coupling device according to the present embodiment;

FIG. 4 is a side view illustrating a movement operation of the carriage coupling device illustrated in FIG. 3;

FIG. 5 is a side view illustrating a coupling preparation operation of the carriage coupling device illustrated in FIG. 3;

FIG. 6 is a side view illustrating a coupling operation of the carriage coupling device illustrated in FIG. 3;

FIG. 7 is a side view illustrating a subsequent operation of FIG. 6;

FIG. 8 is a side view illustrating a coupling release operation of the carriage coupling device illustrated in FIG. 3;

FIG. 9 is an enlarged perspective view of a main part illustrating a drop detection sensor;

FIG. 10 is an enlarged perspective view of a main part illustrating a modification of the drop detection sensor;

FIG. 11 is an enlarged perspective view of a main part illustrating another modification of the drop detection sensor; and

FIG. 12 is a side view illustrating still another modification of the drop detection sensor.

### DETAILED DESCRIPTION OF THE EMBODIMENTS

Hereinafter, a preferred embodiment of a carriage coupling device according to an aspect of the present disclosure will be described in detail with reference to the drawings.

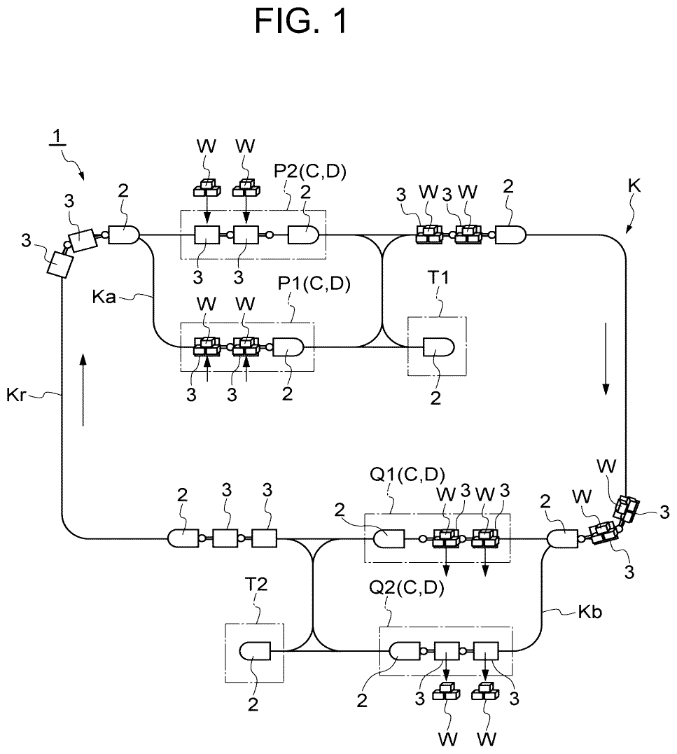

FIG. 1 is a diagram illustrating an example of a travel route in a transport system using a towing vehicle and a carriage. A transport system 1 illustrated in FIG. 1 is a system used for transporting a cargo W in, for example, a large warehouse such as an airport or a factory, and includes a plurality of towing vehicles 2 and a plurality of carriages 3. The towing vehicle 2 automatically travels on a preset travel route K, and couples one or a plurality of carriages 3 as necessary to transport the cargo W. In the example of FIG. 1, a first turn and a second turn to be described later are alternately performed in the transport system 1, and the transport of the cargo W by the towing vehicle 2 and the carriage 3 is continuously performed.

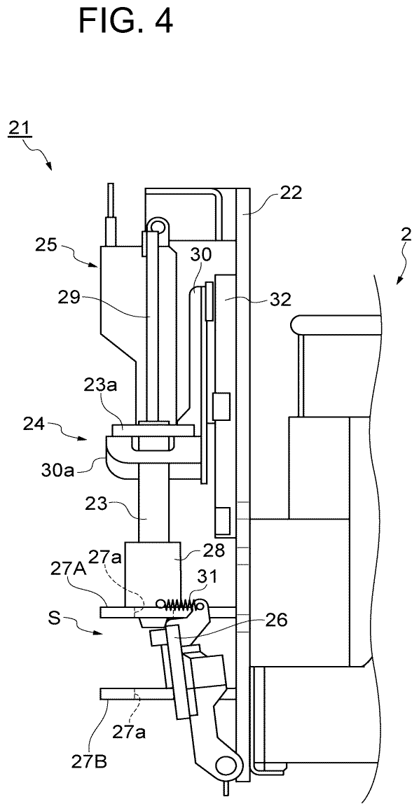

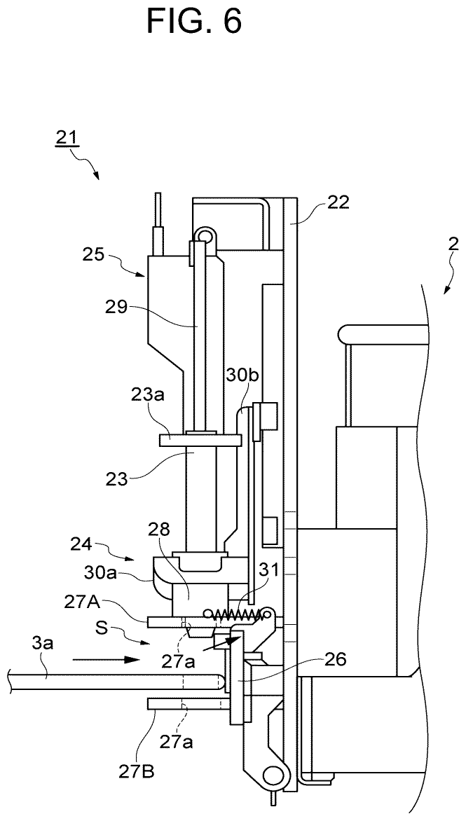

A carriage coupling device 21 to be described later is mounted on the towing vehicle 2. The carriage 3 includes a connector 3a (see FIG. 6 and the like) connected to the carriage coupling device 21. The connector 3a is constituted by, for example, an annular protrusion portion protruding forward from a front portion of the carriage 3. The carriage 3 is coupled to the towing vehicle 2 by an engagement of a coupling pin 23 (see FIG. 4 and the like) of the carriage coupling device 21 with the annular protrusion portion. In addition, the coupling of the carriage 3 to the towing vehicle 2 is released by releasing the engagement of the coupling pin 23 of the carriage coupling device 21 with the annular protrusion portion.

The travel route K is a lap route including a loading position P where the cargo W is loaded, an unloading position Q where the cargo W is unloaded, a coupling position C where the carriage 3 is coupled to the towing vehicle 2, and a coupling release position D where the carriage 3 is disconnected from the towing vehicle 2. The travel route K includes an entire lap route Kr connecting the loading position P and the unloading position Q, a branch route Ka set around the loading position P, and a branch route Kb set around the unloading position Q.

In the branch route Ka, two loading positions P1 and P2 and a standby position T1 of the towing vehicle 2 are set. In the first turn of the transport system 1, the loading position P1 is the coupling position C, and the loading position P2 is the coupling release position D. In the second turn of the transport system 1, the loading position P1 is the coupling release position D, and the loading position P2 is the coupling position C. In the branch route Kb, two unloading positions Q1 and Q2 and a standby position T2 of the towing vehicle 2 are set. In the first turn of the transport system 1, the unloading position Q1 is the coupling release position D, and the unloading position Q2 is the coupling position C. In the second turn of the transport system 1, the unloading position Q1 is the coupling position C, and the unloading position Q2 is the coupling release position D.

In the first turn of the transport system 1, the towing vehicle 2 moves backward from the standby position T1 connected to the branch route Ka to the loading position P1, and the carriage 3 on which the cargo W is placed is coupled at the loading position P1. The towing vehicle 2 tows the carriage 3 on which the cargo W is placed and travels toward the unloading position Q1. At the unloading position Q1, the cargo W is unloaded from the carriage 3, and then the carriage 3 is disconnected from the towing vehicle 2. After the carriage 3 is disconnected, the towing vehicle 2 travels to the standby position T2 connected to the branch route Kb and stands by at the standby position T2.

Next, the towing vehicle 2 moves backward from the standby position T2 to the unloading position Q2, and the carriage 3 on which the cargo W is not placed is coupled at the unloading position Q2. The towing vehicle 2 tows the carriage 3 on which the cargo W is not placed and travels toward the loading position P2. At the loading position P2, the carriage 3 is disconnected from the towing vehicle 2, and then the cargo W is loaded on the carriage. After the carriage 3 is disconnected, the towing vehicle 2 travels to the standby position T1 connected to the branch route Ka and stands by at the standby position T1.

In the second turn of the transport system 1, the towing vehicle 2 moves backward from the standby position T1 to the loading position P2, and the carriage 3 on which the cargo W is placed is coupled at the loading position P2. The towing vehicle 2 tows the carriage 3 on which the cargo W is placed and travels toward the unloading position Q2. At the unloading position Q2, the cargo W is unloaded from the carriage 3, and then the carriage 3 is disconnected from the towing vehicle 2. After the carriage 3 is disconnected, the towing vehicle 2 travels to the standby position T2 connected to the branch route Kb and stands by at the standby position T2.

Next, the towing vehicle 2 moves backward from the standby position T2 to the unloading position Q1, and the carriage 3 on which the cargo W is not placed is coupled at the unloading position Q1. The towing vehicle 2 tows the carriage 3 on which the cargo W is not placed and travels toward the loading position P1. At the loading position P1, the carriage 3 is disconnected from the towing vehicle 2, and then the cargo W is loaded on the carriage. After the carriage 3 is disconnected, the towing vehicle 2 travels to the standby position T1 connected to the branch route Ka and stands by at the standby position T1.

Next, a configuration of the towing vehicle 2 will be described.

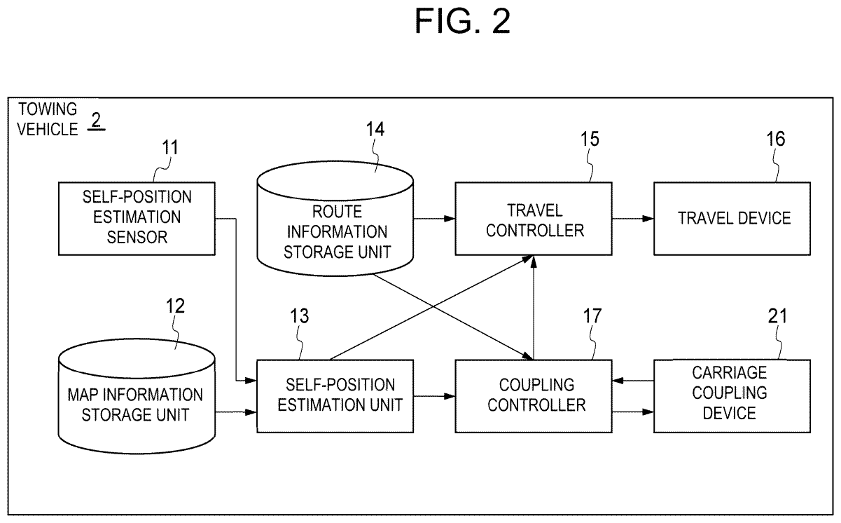

FIG. 2 is a block diagram illustrating a configuration of a towing vehicle to which the carriage coupling device according to the present embodiment is applied. As illustrated in FIG. 2, the towing vehicle 2 includes a self-position estimation sensor 11, a map information storage unit 12, a self-position estimation unit 13, a route information storage unit 14, a travel controller 15, a travel device 16, a coupling controller (controller) 17, and the carriage coupling device 21. Among these components, the map information storage unit 12, the self-position estimation unit 13, the route information storage unit 14, the travel controller 15, and the coupling controller 17 are physically configured by a computer system including a storage device such as a RAM and a ROM, a processor such as a CPU, a communication interface, and the like. In FIG. 2, for convenience of description, the coupling controller 17 and the carriage coupling device 21 are illustrated as separate blocks, but the coupling controller 17 is a component of the carriage coupling device 21.

The self-position estimation sensor 11 is a sensor used to estimate a self-position of the towing vehicle 2. The self-position estimation sensor 11 detects an object existing around the towing vehicle 2. As the self-position estimation sensor 11, for example, a laser sensor such as light detection and ranging (LiDAR) or a laser range finder is used. The self-position estimation sensor 11 irradiates the periphery of the towing vehicle 2 with laser light and receives reflected light of the laser light, thereby detecting a distance from the self-position estimation sensor 11 to an object present around the towing vehicle 2. The self-position estimation sensor 11 outputs detection result information indicating a detection result to the self-position estimation unit 13.

The map information storage unit 12 stores map information about a place where the towing vehicle 2 travels, that is, a place where the travel route K is set. The map information includes, for example, information indicating a building, a pillar, a wall, other obstacles, and the like. The map information may be input in advance by the user of the towing vehicle 2 or may be received from a server or the like via a network.

The route information storage unit 14 is a unit that stores route information related to the travel route K of the towing vehicle 2. The route information includes, in addition to the information indicating the travel route K, information about the loading position P where cargo is loaded and the unloading position Q where cargo is unloaded. That is, the route information includes the coupling position C of the carriage 3 with respect to the towing vehicle 2 and the coupling release position D of the carriage 3 with respect to the towing vehicle 2. As in the map information, the route information may be input in advance by the user of the towing vehicle 2 or may be received from a server or the like via a network.

The self-position estimation unit 13 is a unit that acquires position information about the towing vehicle 2. The self-position estimation unit 13 estimates the self-position of the towing vehicle 2 based on the detection result information from the self-position estimation sensor 11 and the map information stored in the map information storage unit 12. Specifically, the self-position estimation unit 13 estimates the self-position of the towing vehicle 2 by matching the detection result information by the self-position estimation sensor 11 and the map information using, for example, a simultaneous localization and mapping (SLAM) method. The SLAM is a self-position estimation technology that performs self-position estimation using sensor data and map data. The self-position estimation unit 13 outputs estimation result information (position information) indicating an estimation result of the self-position of the towing vehicle 2 to the travel controller 15 and the coupling controller 17.

The travel controller 15 is a unit that controls the operation of the travel device 16. The travel controller 15 refers to the route information stored in the route information storage unit 14 based on the estimation result information output from the self-position estimation unit 13, and controls the travel device 16 so that the towing vehicle 2 travels along the travel route K. When it is detected that an obstacle exists in the vicinity of the towing vehicle 2 by an obstacle detection sensor (not illustrated) or the like, the travel controller 15 controls the travel device 16 so that the towing vehicle 2 decelerates or stops.

The travel device 16 is a device related to traveling of the towing vehicle 2. For example, the device includes a vehicle body, a pair of front wheels disposed at a front portion of the vehicle body, and a pair of rear wheels disposed at a rear portion of the vehicle body. In the travel device 16, for example, the front wheel is a driving wheel, and the rear wheel is a steering wheel. The travel device 16 drives the front wheel and the rear wheel based on the control from the travel controller 15, and causes the towing vehicle 2 to travel along the travel route K.

The coupling controller 17 is a unit that controls the operation of the carriage coupling device 21. The coupling controller 17 controls the coupling operation and the coupling release operation of the connector 3a of the carriage 3. Specifically, the coupling controller 17 refers to the route information stored in the route information storage unit 14 based on the estimation result information output from the self-position estimation unit 13. When determining that the towing vehicle 2 moves from the coupling release position D to the coupling position C of the carriage 3, the coupling controller 17 causes the carriage coupling device 21 to perform the movement operation. The coupling controller 17 causes the carriage coupling device 21 to perform the coupling preparation operation and the coupling operation when determining that the towing vehicle 2 is located at the coupling position C of the carriage 3, and causes the carriage coupling device 21 to perform the coupling release operation when determining that the towing vehicle 2 is located at the coupling release position D of the carriage 3. Details of the movement operation, the coupling preparation operation, the coupling operation, and the coupling release operation will be described later.

Next, a configuration of the carriage coupling device 21 will be described.

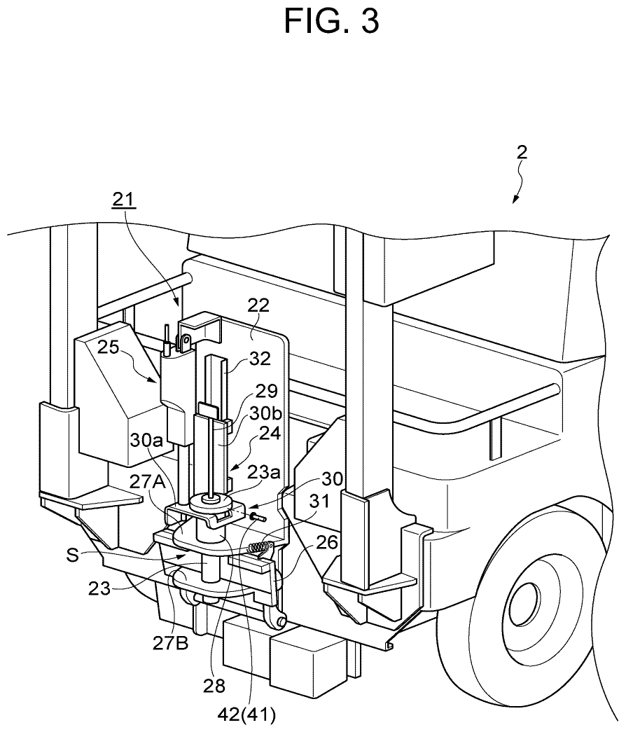

FIG. 3 is a perspective view illustrating a configuration of the carriage coupling device according to the present embodiment. As illustrated in FIG. 3, the carriage coupling device 21 is provided at the rear portion of the towing vehicle 2. The carriage coupling device 21 includes a base plate 22, a coupling pin 23, a holder 24, a driver 25, a stopper 26, and a drop detection sensor 41.

The base plate 22 is a plate serving as a base of the carriage coupling device 21. The base plate 22 has, for example, a rectangular shape, and is disposed at a central part in the width direction of the rear portion of the towing vehicle 2 so that a main surface thereof is directed to the rear side of the towing vehicle 2. A pair of plates having an upper plate 27A and a lower plate 27B is provided on a lower part of the base plate 22. The plates 27A and 27B have, for example, an isosceles trapezoidal shape to have a bottom side at the base plate 22 when viewed in the height direction of the towing vehicle 2.

The plates 27A and 27B are disposed in parallel to each other in a state of being away from each other at a predetermined interval in the height direction of the towing vehicle 2, and protrude from the base plate 22 to the rear of the towing vehicle 2. The space between the plates 27A and 27B is an insertion position S into which the connector 3a of the carriage 3 to be coupled is inserted. The plates 27A and 27B have respective holes 27a coaxially (see FIG. 4 and the like) through which the coupling pin 23 is insertable. The upper plate 27A is provided with a tubular guide 28 protruding upward around the hole 27a. A guide member (not illustrated) that guides the connector 3a of the carriage 3 toward the insertion position S may be attached to the lower plate 27B.

The coupling pin 23 is a pin that engages with the connector 3a when the carriage 3 is coupled. The coupling pin 23 is configured to drop along the guide 28 toward the insertion position S into which the connector 3a of the carriage 3 is inserted. Specifically, the coupling pin 23 has a tubular shape with a diameter which is insertable through the holes 27a of the plates 27A and 27B and the guide 28. For example, a circular flange 23a is provided at an upper end portion of the coupling pin 23. The drop of the coupling pin 23 is restricted at a position where the flange 23a contacts the upper end of the guide 28. When the coupling pin 23 drops and the flange 23a contacts the upper end of the guide 28, the coupling pin 23 is inserted through the hole 27a of each of the plates 27A and 27B and advanced to the insertion position S between the plates 27A and 27B.

In the present embodiment, the coupling pin 23 is provided with a handle portion 29 protruding upward above the flange 23a. The handle portion 29 includes, for example, a rod-shaped portion having a diameter smaller than that of the main body of the coupling pin 23 and a plate-shaped gripping portion provided at the distal end of the rod-shaped portion. By providing the handle portion 29, it is possible to easily correct the position of the coupling pin 23 by manually pulling up the handle portion 29 in a case where the drop position of the coupling pin 23 is shifted.

The holder 24 is a unit that holds the coupling pin 23 in a vertically movable manner. In the present embodiment, the holder 24 includes a linear motion table 30 that is moved up and down by the driver 25. The linear motion table 30 has a table portion 30a engaged with the coupling pin 23 and an engagement portion 30b engaged with a linear motion guide 32. The table portion 30a has a frame shape through which the coupling pin 23 and the guide 28 are insertable and is mechanically connected to the driver 25. While the coupling pin 23 is inserted through the table portion 30a, the table portion contacts the lower part of the flange 23a of the coupling pin 23. The engagement portion 30b protrudes upward from an edge portion of the table portion 30a on the towing vehicle 2 side, and is engaged with the linear motion guide 32 provided on the base plate 22.

The driver 25 is a unit that automatically switches between the holding state and the non-holding state of the coupling pin 23 by the holder 24. The driver 25 includes an actuator such as an electric cylinder. In the present embodiment, the driver 25 smoothly moves the linear motion table 30 up and down in the vertical direction between the upper end position and the lower end position along the linear motion guide 32. In a case where the coupling pin 23 is located above (the position retracted from the insertion position S) and the table portion 30a of the holder 24 is located at the upper end position and is in contact with the lower part of the flange 23a, the coupling pin 23 is in the holding state and the drop of the coupling pin 23 is restricted.

In a case where the coupling pin 23 is located above (the position retracted from the insertion position S) and the table portion 30a of the holder 24 is located at the lower end position and is not in contact with the lower part of the flange 23a, the coupling pin 23 is in the non-holding state, and the coupling pin 23 is allowed to drop. When the linear motion table 30 rises after the coupling pin 23 drops, the linear motion table 30 and the coupling pin 23 rise together due to the engagement of the table portion 30a with the flange 23a.

The stopper 26 is a unit that restricts the drop of the coupling pin 23. In the present embodiment, the lower end portion of the stopper 26 is rotatably and pivotally supported at the lower end portion of the base plate 22, and the upper end portion of the stopper 26 is coupled to a spring 31 attached to the side face of the upper plate 27A. The stopper 26 is biased by a spring 31 so as to advance to the insertion position S. In the state of advancing to the insertion position S, the upper end portion of the stopper 26 supports the lower end portion of the coupling pin 23 before dropping above the insertion position S.

The stopper 26 is retracted from the insertion position S by being pushed in a direction opposite to the biasing direction by the spring 31 by the connector 3a of the carriage 3 that has entered the insertion position S. In the state retracted from the insertion position S, the support of the lower end portion of the coupling pin 23 by the upper end portion of the stopper 26 is released, and the coupling pin 23 is allowed to drop to the insertion position S.

The drop detection sensor 41 is a sensor that detects the drop of the coupling pin 23 to the insertion position S. In the present embodiment, the drop detection sensor 41 detects the position of the upper end portion of the coupling pin 23 when the coupling pin 23 drops into the insertion position. Here, the drop detection sensor 41 includes, for example, a proximity sensor 42. The proximity sensor 42 is a sensor that generates an electric field in a coil in the head and detects a change in the electric field due to approach of metal. The proximity sensor 42 is disposed toward the position of the flange 23a when the coupling pin 23 drops, that is, the position where the flange 23a contacts the upper end of the guide 28. When detecting that the flange 23a contacts the upper end of the guide 28 based on the difference in diameter between the main body of the coupling pin 23 and the flange 23a, the proximity sensor 42 outputs detection information indicating detection of the drop of the coupling pin 23 to the insertion position S to the coupling controller 17.

When receiving the detection information indicating detection of the drop of the coupling pin 23 to the insertion position S from the drop detection sensor 41, the above-described coupling controller 17 outputs instruction information to stop the backward movement of the towing vehicle 2 to the travel controller 15 of the towing vehicle 2. When receiving the instruction information from the coupling controller 17, the travel controller 15 controls the travel device 16 so that the backward movement of the towing vehicle 2 is stopped.

Next, the operation of the carriage coupling device 21 will be described.

As described above, the carriage coupling device 21 performs each operation of the movement operation, the coupling preparation operation, the coupling operation, and the coupling release operation based on the control of the coupling controller 17. The movement operation is an operation applied to a period in which the towing vehicle 2 moves from the coupling release position D to the coupling position C of the carriage 3. In the transport system 1 illustrated in FIG. 1, the movement operation is basically applied when the towing vehicle 2 travels on the entire lap route Kr, branch route Kb, and branch route Kb without the carriage 3 coupled except when the towing vehicle 2 is stopped at the coupling position C and the coupling release position D.

In the movement operation, the coupling pin 23 supported by the stopper 26 is held in a holding state by the holder 24. In the movement operation, as shown in FIG. 4, the linear motion table 30 is at the upper end position, and the coupling pin 23 is held at the upper position at which the pin is retracted from the insertion position S. The stopper 26 is biased to advance to the insertion position S, and supports the lower end portion of the coupling pin 23 above the insertion position S in a state of advancing to the insertion position S.

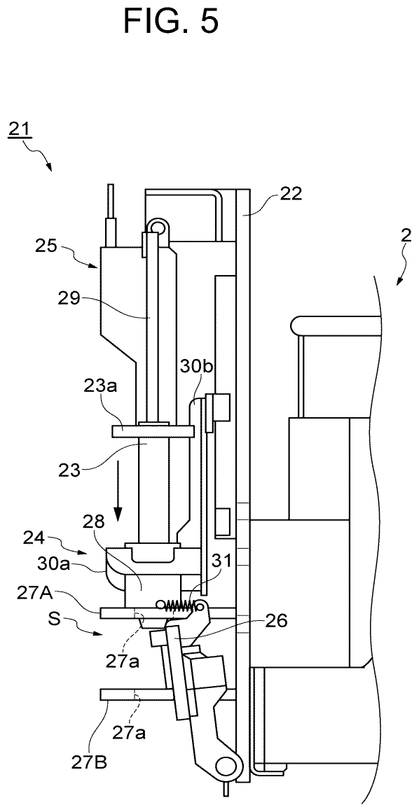

The coupling preparation operation and the coupling operation are operations applied when the towing vehicle 2 is located at the coupling position C of the carriage 3. In the coupling preparation operation, the coupling pin 23 supported by the stopper 26 is brought into a non-holding state by the holder 24. In the coupling preparation operation, as illustrated in FIG. 5, the driver 25 lowers the linear motion table 30 from the upper end position to the lower end position. As a result, the coupling pin 23 is brought into the non-holding state, and the coupling pin 23 is allowed to drop. However, in the coupling preparation operation, a state in which the stopper 26 has advanced to the insertion position S is maintained. Therefore, the lower end portion of the coupling pin 23 remains supported by the stopper 26, and the coupling pin 23 continues to be held at the upper position at which the pin is retracted from the insertion position S.

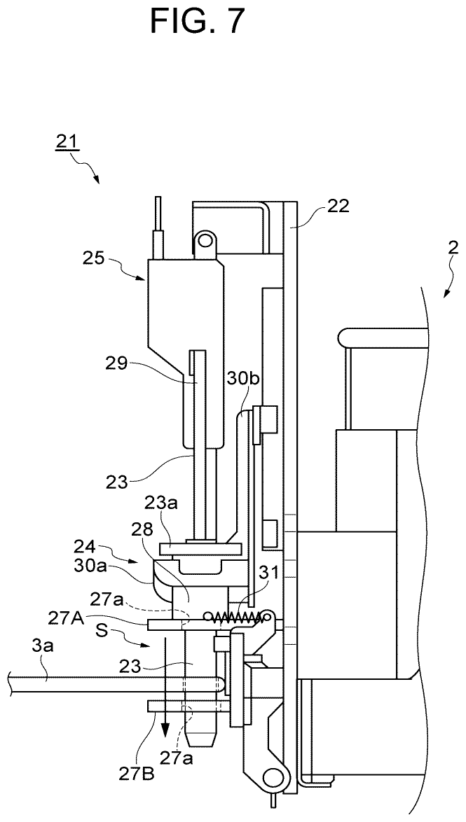

In the coupling operation, as illustrated in FIG. 6, when the connector 3a of the carriage 3 is inserted into the insertion position S, the stopper 26 pushed by the connector 3a is retracted from the insertion position S. When the stopper 26 retracts from the insertion position S, the coupling pin 23 drops into the insertion position S and engages with the connector 3a at the insertion position S as illustrated in FIG. 7. Accordingly, the carriage 3 is coupled to the towing vehicle 2.

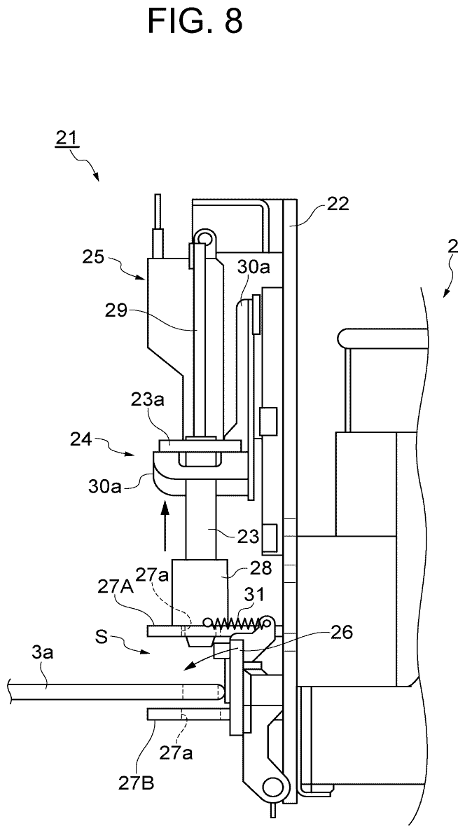

The coupling release operation is an operation applied when the towing vehicle 2 is located at the coupling release position D of the carriage 3. In the coupling release operation, as illustrated in FIG. 8, the linear motion table 30 rises from the lower end position to the upper end position by the driver 25. Accordingly, the coupling pin 23 rises to the upper position together with the linear motion table 30 and retracts from the insertion position S. When the coupling pin 23 retracts from the insertion position S, the engagement of the coupling pin 23 with the connector 3a is released, and the coupling of the towing vehicle 2 to the carriage 3 is released. After the coupling is released, when the connector 3a retracts from the insertion position S, the stopper 26 advances to the insertion position S by the biasing of the spring 31. As a result, the lower end portion of the coupling pin 23 at the upper position is held, and the operation shifts to the movement operation illustrated in FIG. 4.

During the coupling preparation operation and the coupling operation described above, the travel controller 15 controls the backward movement of the towing vehicle 2 by the travel device 16 in consideration of an error in the position of the carriage 3 at the coupling position C. Assuming that the error is, for example, ±X mm from the reference position of the carriage 3 in the traveling direction of the towing vehicle 2, in order for the coupling pin 23 to be more reliably inserted by the connector 3a of the carriage 3, the traveling of the towing vehicle 2 is controlled so that the towing vehicle 2 moves backward to a position (the position of −X mm from the reference) of the carriage 3, the position being farthest from the towing vehicle 2.

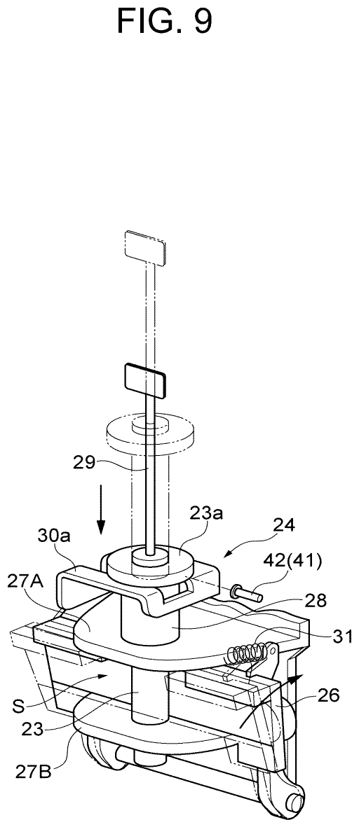

On the other hand, in the carriage coupling device 21, when the connector 3a of the carriage 3 is inserted into the insertion position S in the coupling operation, and the coupling pin 23 drops into the insertion position S due to the retraction of the stopper 26, as illustrated in FIG. 9, the drop of the coupling pin 23 to the insertion position S is detected by the drop detection sensor 41. Here, the proximity sensor 42 detects that the flange 23a contacts the upper end of the guide 28 due to the drop of the coupling pin 23, whereby the drop of the coupling pin 23 is detected.

When the drop of the coupling pin 23 is detected, detection information indicating the result is output to the coupling controller 17, and instruction information to stop the backward movement of the towing vehicle 2 is output from the coupling controller 17 to the travel controller 15 of the towing vehicle 2. The backward movement of the towing vehicle 2 is stopped by the control by the travel controller 15 that has received the instruction information. That is, in the towing vehicle 2 to which the carriage coupling device 21 is applied, when the carriage 3 is coupled, the traveling of the towing vehicle 2 is controlled so that the towing vehicle 2 moves backward to a position (the position of −X mm from the reference) of the carriage 3, the position being farthest from the towing vehicle 2, but even if a travel distance from the reference to the position of −X mm remains, the backward movement of the towing vehicle 2 stops at the time when the drop of the coupling pin 23 is detected.

As described above, in the carriage coupling device 21, when the connector 3a of the carriage 3 is inserted into the insertion position S, the stopper 26 pushed by the connector 3a is retracted from the insertion position S. When the stopper 26 retracts from the insertion position S, the coupling pin 23 drops into the insertion position S and engages with the connector 3a, and the towing vehicle 2 and the carriage 3 are coupled.

In addition, in the carriage coupling device 21, when the drop of the coupling pin 23 to the insertion position S is detected by the drop detection sensor 41, instruction information to stop the backward movement of the towing vehicle 2 is output to the travel controller 15 of the towing vehicle 2. As a result, even when the traveling of the towing vehicle 2 is controlled in consideration of the error in the position of the carriage 3 at the time of connection, the towing vehicle 2 stops at the timing when the coupling pin 23 drops, and it is possible to suppress the backward movement of the carriage 3 due to being pushed by the towing vehicle 2. Therefore, it is possible to set an entry prohibition area for persons and objects without taking into consideration the deviation of the carriage in the width direction at the time of the backward movement, and it is possible to increase the degree of freedom of the layout of the transport system using the towing vehicle and the carriage.

In the present embodiment, the drop detection sensor 41 is a sensor that detects the position of the upper end portion of the coupling pin 23 when the coupling pin 23 drops into the insertion position S. In the present embodiment, the drop detection sensor 41 includes the proximity sensor 42, and the proximity sensor 42 detects the flange 23a provided at the upper end portion of the coupling pin 23 to detect the drop of the coupling pin 23. According to such a configuration, the drop of the coupling pin 23 to the insertion position S can be accurately detected.

In the present embodiment, the carriage coupling device 21 includes the holder 24 that holds the coupling pin 23 in a vertically movable manner, and the driver 25 that automatically switches between the holding state and the non-holding state of the coupling pin 23 by the holder 24. As a result, it is not necessary for the operator to manually perform the coupling operation and the coupling release operation of the connector 3a of the carriage 3, and efficiency of work using the towing vehicle 2 and the carriage 3 is improved.

In the present embodiment, the carriage coupling device 21 includes a pair of plates having an upper plate 27A and a lower plate 27B having the respective holes 27a through which the coupling pin 23 is insertable. The upper plate 27A of the plates 27A and 27B is provided with the guide 28 in a tubular shape so that the guide 28 protrudes around the hole 27a, and the coupling pin 23 has the flange 23a that contacts the guide 28 when the coupling pin 23 drops into the insertion position S. As a result, the drop operation of the coupling pin 23 is stabilized by the holes 27a of the plates 27A and 27B, the tubular guide 28, and the flange 23a contacting the guide 28. In addition, since the position of the flange 23a when the coupling pin 23 drops is defined by the guide 28, the detection accuracy of the drop of the coupling pin 23 by the proximity sensor 42 described above can be sufficiently secured.

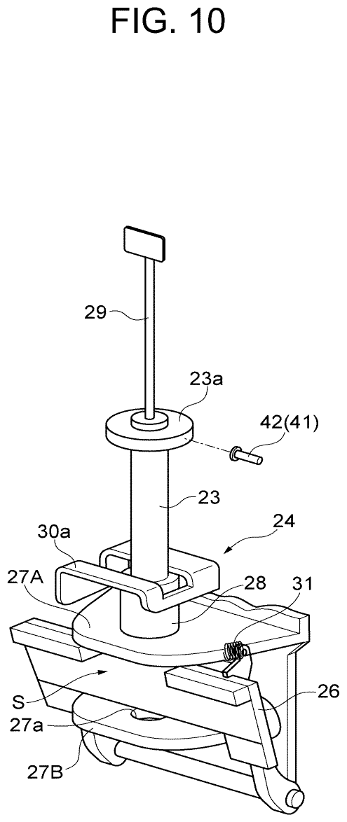

The present disclosure is not limited to the above embodiments. For example, in the above embodiment, the drop detection sensor 41 is a sensor that detects the position of the upper end portion of the coupling pin 23 when the coupling pin 23 drops into the insertion position S. However, as illustrated in FIG. 10, the drop detection sensor 41 may be a sensor that detects the position of the upper end portion of the coupling pin 23 when the coupling pin 23 is supported by the stopper 26.

In the example of FIG. 10, as in the above embodiment, the drop detection sensor 41 includes the proximity sensor 42. The proximity sensor 42 is disposed toward the position of the flange 23a when the coupling pin 23 is supported by the stopper 26. When the flange 23a is not detected at this position, the proximity sensor 42 outputs detection information indicating detection of the drop of the coupling pin 23 to the insertion position S to the coupling controller 17. Even with such a configuration, as in the above embodiment, the towing vehicle 2 stops at the timing when the coupling pin 23 drops, and it is possible to suppress the backward movement of the carriage 3 caused by being pushed by the towing vehicle 2.

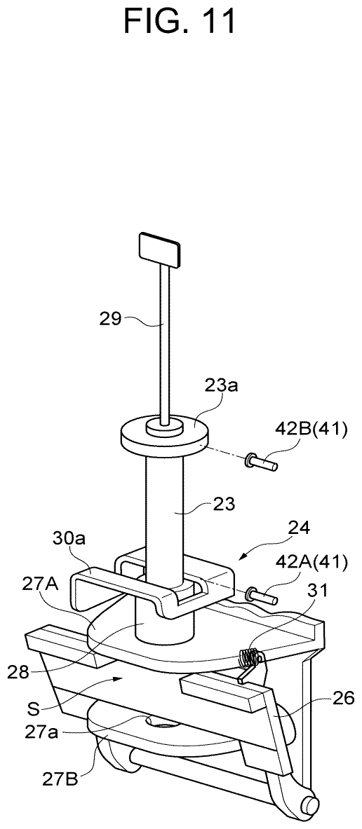

As illustrated in FIG. 11, the drop detection sensor 41 may include a lower proximity sensor 42A that detects the position of the upper end portion of the coupling pin 23 when the coupling pin 23 drops into the insertion position S, and an upper proximity sensor 42B that detects the position of the upper end portion of the coupling pin 23 when the coupling pin 23 is supported by the stopper 26. In this case, the instruction information from the coupling controller 17 to the travel controller 15 may be output based on the detection information from the proximity sensor 42 that has detected the drop of the coupling pin 23 first. Even in such a configuration, as in the above embodiment, the backward movement of the towing vehicle 2 is stopped at the timing when the coupling pin 23 drops, and the backward movement of the carriage 3 caused by being pushed by the towing vehicle 2 can be suppressed.

In this configuration, when the coupling pin 23 drops normally, the upper proximity sensor 42 detects the drop of the coupling pin 23, and then the lower proximity sensor 42 detects the drop of the coupling pin 23. Therefore, when there is a problem in the drop operation of the coupling pin 23, it is easy to detect an abnormality and identify a factor of the abnormality by checking the presence or absence of the detection or the detection timing in each proximity sensor 42.

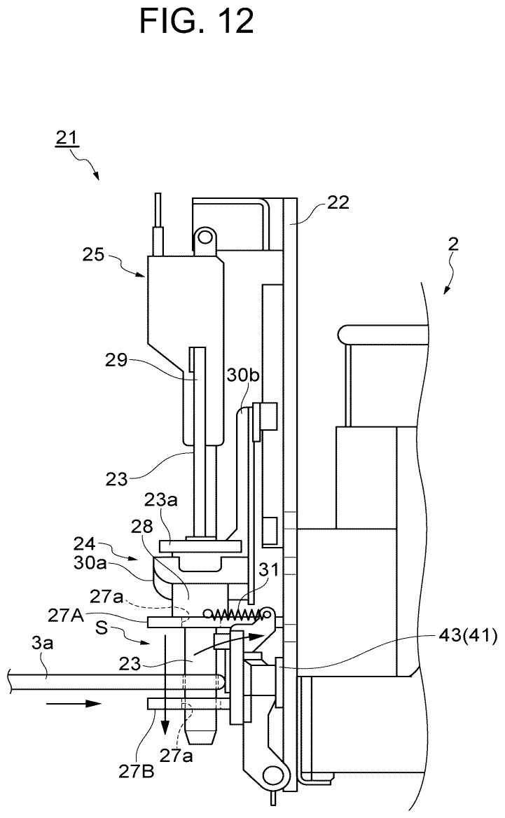

Furthermore, as illustrated in FIG. 12, the drop detection sensor 41 may be a sensor that detects that the stopper 26 has retracted from the insertion position S. In the example of FIG. 12, the drop detection sensor 41 includes a contact sensor 43 that detects that an object has come into contact with a contact. The contact sensor 43 is attached to, for example, a lower portion of the base plate 22, comes into contact with the stopper 26 when the stopper 26 is pushed by the connector 3a and retracts from the insertion position S, and outputs detection information indicating that the drop of the coupling pin 23 to the insertion position S is detected to the coupling controller 17. Even with such a configuration, as in the above embodiment, the towing vehicle 2 stops at the timing when the coupling pin 23 drops, and it is possible to suppress the backward movement of the carriage 3 caused by being pushed by the towing vehicle 2.

The drop detection sensor 41 may be configured by combining at least two of a sensor that detects the position of the upper end portion of the coupling pin 23 when the coupling pin 23 drops to the insertion position S, a sensor that detects the position of the upper end portion of the coupling pin 23 when the coupling pin 23 is supported by the stopper 26, and a sensor that detects retraction of the stopper 26 from the insertion position S. In this case, the drop of the coupling pin 23 to the insertion position S can be detected with higher accuracy. In addition, when there is a problem in the drop operation of the coupling pin 23, it is easy to detect an abnormality and identify a factor of the abnormality.

What is claimed is:

1. A carriage coupling device that couples a carriage to a towing vehicle, the carriage coupling device comprising:
a coupling pin configured to drop along a guide toward an insertion position into which a connector of the carriage is inserted;
a stopper that is biased to advance to the insertion position, supports the coupling pin above the insertion position in an advanced state to the insertion position, and allows the coupling pin to drop to the insertion position when retracting from the insertion position;
a drop detection sensor that detects a drop of the coupling pin to the insertion position; and
a controller that outputs instruction information to stop a backward movement of the towing vehicle to a travel controller of the towing vehicle when the drop detection sensor detects the drop of the coupling pin to the insertion position.

2. The carriage coupling device according to claim 1, wherein
the drop detection sensor is a sensor that detects a position of an upper end portion of the coupling pin when the coupling pin drops to the insertion position.

3. The carriage coupling device according to claim 1, wherein
the drop detection sensor is a sensor that detects a position of an upper end portion of the coupling pin when the coupling pin is supported by the stopper.

4. The carriage coupling device according to claim 1, wherein
the drop detection sensor is a sensor that detects retraction of the stopper from the insertion position.

5. The carriage coupling device according to claim 1, wherein
the drop detection sensor is configured by combining at least two of a sensor that detects a position of an upper end portion of the coupling pin when the coupling pin drops to the insertion position, a sensor that detects the position of the upper end portion of the coupling pin when the coupling pin is supported by the stopper, and a sensor that detects retraction of the stopper from the insertion position.

6. The carriage coupling device according to claim 1, further comprising:
a holder that holds the coupling pin in a vertically movable manner; and
a driver that automatically switches between a holding state and a non-holding state of the coupling pin by the holder.

7. The carriage coupling device according to claim 1, further comprising:
a pair of plates having an upper plate and a lower plate having respective holes through which the coupling pin is insertable, wherein
the upper plate of the pair of plates is provided with the guide in a tubular shape so that the guide protrudes around the hole of the upper plate, and
the coupling pin has a flange that contacts the guide when dropping into the insertion position.
